(19) United States
(12) Patent Application Publication
(10) Pub. No.: US 2016/0247195 A1
(43) Pub. Date: Aug. 25, 2016

(54) Social Media Experiential Platform System and Methods

(71) Applicants: James Christopher Hopper, Oreland, PA (US); Peter Joseph Wells, New York, NY (US)

(72) Inventors: James Christopher Hopper, Oreland, PA (US); Peter Joseph Wells, New York, NY (US)

(73) Assignee: Fotofwd, Inc., New York, NY (US)

(21) Appl. No.: 15/047,616

(22) Filed: Feb. 18, 2016

Related U.S. Application Data
(60) Provisional application No. 62/118,410, filed on Feb. 19, 2015.

(51) Int. Cl. G06Q 30/02; G06Q 50/00; G06F 3/12; H04W 4/00

(52) U.S. Cl. CPC G06Q 30/0255; H04W 4/008; G06Q 50/01; G06F 3/1227; G06F 3/1236; G06F 3/1292; G06F 3/1288

(57) ABSTRACT

A social media experiential platform and method for establishing the operation thereof is disclosed. The social media experiential platform comprises users, subscribers, and sponsors. Users capture digital images at an event hosted by a subscriber. Thereafter, the user can post the digital images to a plurality of social network providers and/or print digital images via various printing methods utilizing a unified interface. In some embodiments, there is no cost to the user for printing the digital images and the printing materials are provided to the subscriber at no cost. In turn, each post and/or print of a digital image includes a plurality of tags to promote a sponsor and/or subscriber. As a result, subscribers can generate social media awareness and visibility while offering users a unique service at no cost, and sponsors can reach a targeted, measurable audience via print, video display, and web advertising.

### CROSS-REFERENCE TO RELATED APPLICATION

The present application claims priority to U.S. Provisional Application Ser. No. 62/118,410, filed Feb. 19, 2015 and entitled “Social Media Printing Platform System and Method,” which is hereby incorporated by reference herein in its entirety, including any figures, tables, equations, or drawings.

### TECHNICAL FIELD

The present invention relates generally to a business method that provides for a social media experiential platform offering reach to consumers through branded prints, video advertising, and event sponsorships.

### BACKGROUND

More photos are taken now than ever before due to advancements in digital imaging technologies. Various electronic devices such as digital cameras, smart phones, smartwatches, and tablets have the capability to capture digital images. Photo sharing of such digital images has proliferated with the gaining popularity of social media platforms, for example, Facebook®, Instagram®, Twitter®, FourSquare®, Weibo®, SnapChat®, WhatsApp® and Pinterest®. According to reports issued by social media platforms, an estimated 1.3 billion digital images are shared on social media platforms daily. As of the writing of this application, the Facebook® website reports that an estimated 250 billion photos have been uploaded to Facebook® alone, and this figure continues to increase as an estimated 350 million digital images are uploaded daily (4,000 uploads per second) to Facebook®. According to the Instagram® website, as of the date of this application, the social media provider Instagram® is estimated to include 200 million active users sharing digital images.

However, the methods for printing individual digital images has not kept pace with the various means for capturing digital images. Generally, digital images can be printed utilizing home printing devices, prints-by-mail services, printing kiosks, photo booths, and event printing services. A disadvantage inherent in all these printing solutions is the requirement of effort, time, and money from customers to utilize the formats and portal specific to each service.

Many leading technology companies manufacture photo printing devices for in-home use, including, e.g., Hewlett Packard®, Dell®, Polaroid®, and others. The disadvantage of home printing options is the upfront purchase of equipment and recurring costs associated with replenishment of ink and paper supplies. Many websites and retailers offer services to upload digital images for delivery by mail. A disadvantage of such services is that orders may require a minimum purchase and can require customers to bear the cost of shipping. Further, delivery is often available to customers by express or standard delivery rather than immediately or within hours.

Retail locations including supermarkets, drug stores, and specialty photography outlets offer digital image printing through interactive self-service kiosks. The available features, services, and connectivity of such printing kiosks can vary widely by location. In addition, on-location staff is often required for maintenance and supply replenishment. The disadvantages of printing kiosks include the physical presence requirement, connectivity issues when transferring digital images from an electronic device with network capabilities to the kiosk, and utilizing an unfamiliar interface.

Recently, photo booths have achieved resurgence in popularity due to their ease of use and ability to instantly capture memories. Various manufacturers sell photo booths to locations such as bars and entertainment venues with adequate space for such equipment. Photo booths, however, lack the capability to capture all the action outside of the booth. Further, a number of regional operators throughout the United States provide event printing services through portable photo booths and other printing equipment via smartphones. Options and capabilities vary widely by company. Furthermore, the costs associated with the printing materials are typically borne by the venue which can be passed on to the consumer.

There is a need in the art for a social media experiential platform that provides a unified experience for printing digital images at no cost to the consumer. Further, there is a need for a social media printing platform that provides the printing materials to a venue at no cost, thereby allowing a venue to differentiate itself from its competitors.

Social media, although a relatively recent phenomenon, is becoming an increasingly important aspect of any business plan for marketing and developing a client base. It is estimated that seventy-two percent of online adults use social media providers. Further, forty-three percent of individuals between the age of twenty and twenty-nine spend more than ten hours per week on social media providers. As a result, ninety-three percent of marketers use social media for businesses. It is estimated that ninety-four percent of businesses with a marketing department use social media as part of their marketing platform. Eighty-five percent of businesses that have a dedicated social media platform as part of their marketing strategy report an increase in their market exposure. At least fifty-eight percent of businesses that have used social media marketing for over three years report an increase in sales over that period of time. As a result, businesses seeking to secure a place in the digital marketplace require a robust and responsive utilization of the tools social media providers offer.

Advertising on social media providers is a significant market opportunity that is still emerging and evolving. According to some reports, social media advertising revenue is expected to grow seventy-eight percent by 2017 to nearly $12 billion, up from $6.7 billion dollars in 2013. Advertisers are increasingly using social media's unique combination of reach, relevance, social context, and engagement to enhance the value of advertisements.

In addition to social media advertising, the traditional out-of-home (OOH) advertising remains relevant. OOH advertising includes billboards, street furniture (such as bus shelters and kiosks), transit displays (such as bus sides, on-train print, and taxi toppers), sports arena displays, captive ad networks (in venues such as elevators), and other formats. The out-of-home advertising market is expected to grow by 5.6 percent on a compound annual basis from $26.1 billion in 2010 to $34.2 billion in 2015.

Digital billboards and digital networks still represent only a small part of the OOH advertising, but the adoption of such technology is expected to outpace those of traditional mediums. The growth of digital networks can invigorate the OOH industry, making it one of the faster-growing segments of the overall advertising market. Emerging technologies such as the use of interactive touch screens, QR (quick response) codes, and geographic segmentation, offer the ability to download and print coupons.

In view of the forgoing, a need exists for a social media experiential platform for distributing out-of-home advertising through the digital images printed by consumers. Consumers are encouraged to distribute out-of-home advertising, because the digital images are printed at no cost to the consumer.

There is a need in the art for a social media experiential platform wherein a venue/event subscriber of the social media experiential platform prints the digital images at no cost for the printing materials. In some embodiments, the venue/event subscriber pays a recurring monthly fee. In turn the venue/event subscriber can benefit from a differentiated customer experience that provides digital image printing at no costs to the customer.

In addition, a need exists for a social media experiential platform that provides a unified interface to post digital images to a plurality of social media providers and various methods of printing digital images. Each digital image post can include tags to promote venues and sponsors.

A further need exists for a social media experiential platform that aggregates the digital images captured at an event from various users. The venue/event subscriber and sponsor of the social media printing platform can have access to all of the digital images printed and/or posted related to the event. Further, such digital images can be provided to other users at the event.

### SUMMARY OF THE INVENTION

The present disclosure provides a social media experiential platform and method for establishing the operation thereof. The social media experiential platform comprises users, venue/event subscribers, and sponsors. Users capture digital images at an event hosted by a venue/event subscriber. Thereafter, the user can post the digital images to a plurality of social network providers and/or print digital images via various printing methods utilizing a unified interface. In some embodiments, there is no cost to the user for printing the digital images. In turn, each post and/or print of a digital image includes a plurality of tags to promote a sponsor and/or venue/event subscriber. Further, the printing materials are provided to the venue/event subscriber at no cost. In this example, the sponsors pay the costs associated with the user printing a digital image. In turn, sponsors gain enhanced social media presence through tags automatically included in posts and/or digital images printed utilizing the social media printing platform. As a result, the social media experiential platform delivers a compelling and unique value proposition to all constituents: users are offered digital images at no printing cost; venue/event subscribers generate social media awareness, visibility, brand affiliation and promotion while offering their customers a unique service at no cost to their customers and no cost for the printing material; and sponsors can reach a targeted, measurable audience via print, video display, mobile, social and web advertising. Further, the social media experiential platform turns personal experiences through social media (check-ins, uploading photos, uploading videos, reviews, purchases, etc.) into social currency. The social media experiential platform allows users to create social currency by exchanging and engaging their digital social media experiences via their computing devices (e.g. smartphone, tablet, laptop, etc) and Short Message Service (SMS) for physical options to print photos and get offers and discounts for products and services.

### BRIEF DESCRIPTION OF THE DRAWINGS

The detailed description makes reference to the accompanying figures wherein:

FIG. 1 illustrates an exemplary social media experiential platform according to the preferred embodiment of the present invention;

FIG. 2 illustrates a user login interface in accordance with the preferred embodiment of the present invention;

FIG. 3 illustrates a user stream interface in accordance with the preferred embodiment of the present invention;

FIG. 4 illustrates a user photo detail interface in accordance with the preferred embodiment of the present invention;

FIG. 5 illustrates a user photo gallery interface in accordance with the preferred embodiment of the present invention;

FIG. 6A illustrates a user experience for selecting digital images to print in accordance with the preferred embodiment of the present invention;

FIG. 6B illustrates a user image selection interface in accordance with the preferred embodiment of the present invention;

FIG. 6C illustrates a user print preview interface in accordance with the preferred embodiment of the present invention;

FIG. 6D illustrates a user print option interface in accordance with the preferred embodiment of the present invention;

FIG. 7A illustrates a user experience for selecting a print location for a digital image in accordance with the preferred embodiment of the present invention;

FIG. 7B illustrates a user print location preview for a digital image in accordance with the preferred embodiment of the present invention;

FIG. 7C illustrates a user print location preview interface for a retail location in accordance with the preferred embodiment of the present invention;

FIG. 7D illustrates a user print location preview interface for a social media experiential module in accordance with the preferred embodiment of the present invention;

FIG. 8 illustrates a user post interface in accordance with the preferred embodiment of the present invention;

FIG. 9A illustrates a user experience for a print order confirmation in accordance with the preferred embodiment of the present invention;

FIG. 9B illustrates a user print order confirmation interface for a retail location in accordance with the preferred embodiment of the present invention;

FIG. 9C illustrates a user print order confirmation interface for a print by mail service in accordance with the preferred embodiment of the present invention;

FIG. 9D illustrates a user print order confirmation interface for a social media provider and social media experiential platform module in accordance with the preferred embodiment of the present invention;

FIG. 10A illustrates an exemplary process in accordance with an embodiment of the present invention;

FIG. 10B illustrates an exemplary process in accordance with an embodiment of the present invention;

FIG. 11A illustrates an exemplary process in accordance with an embodiment of the present invention;

FIG. 11B illustrates an exemplary process in accordance with an embodiment of the present invention;

FIG. 11C illustrates an exemplary process in accordance with an embodiment of the present invention;

FIG. 12A illustrates an exemplary process in accordance with an embodiment of the present invention;

FIG. 12B illustrates an exemplary process in accordance with an embodiment of the present invention;

FIG. 13A illustrates an exemplary process in accordance with an embodiment of the present invention;

FIG. 13B illustrates an exemplary process in accordance with an embodiment of the present invention;

FIG. 14A illustrates an exemplary process in accordance with an embodiment of the present invention;

FIG. 14B illustrates an exemplary process in accordance with an embodiment of the present invention;

FIG. 15A illustrates an exemplary process flow in accordance with an embodiment of the present invention; and

FIG. 15B illustrates an exemplary process flow in accordance with an embodiment of the present invention;

Other objects, features, and characteristics of the present invention, as well as methods of operation and functions of the related elements of the structure and the combination of parts, will become more apparent upon consideration of the following detailed description with reference to the accompanying drawings.

### DETAILED DESCRIPTION OF THE PREFERRED EMBODIMENT

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein.

None of the terms used herein, including “device,” “platform,” “module,” and “view” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected” or any variant thereof, means any connection or coupling, either direct or indirect, electronic or otherwise, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the Detailed Description of the Preferred Embodiment using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description of the preferred embodiment of the present invention with reference to the figures.

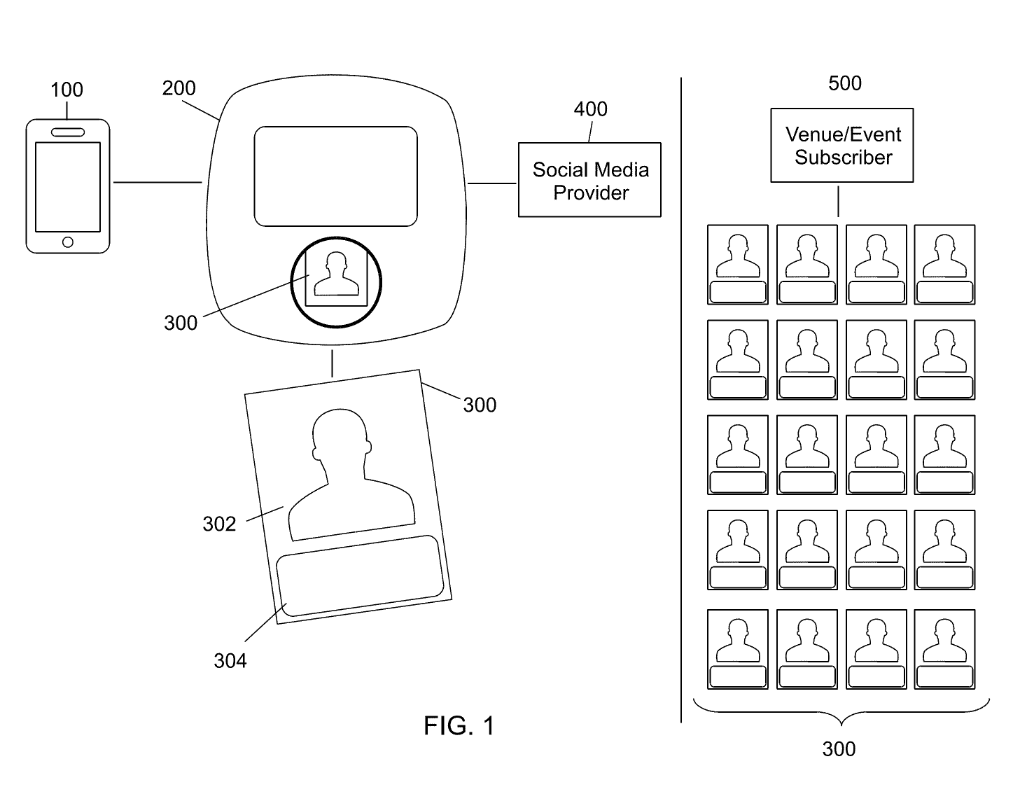

Referring initially to FIG. 1, an exemplary social media experiential platform according to the preferred embodiment of the present invention is shown. Generally, the social media experiential platform can be implemented on a combination of hardware and software. In the preferred embodiment, the techniques disclosed herein are implemented in a software environment such as an operating system or in an application running on an operating system. This software can include, but is not limited to, resident software, firmware, etc., or is implemented on a cloud-based or visualized network system. The photo printing aspect of the social media printing platform is implemented in hardware. This hardware can include, but is not limited to a self-printing kiosk, photo printer, or a photo printing service.

Computing device 100, a device designed to interact with a network system, communicates over a network with the social media printing platform. The network can be a local area network (LAN), a wide area network (WAN), the Internet, cellular networks, satellite networks or any other network that permits the transfer and/or reception of data to and/or from computing device 100. The data transmitted to or from computing device 100 and the social media experiential platform through the network can be transmitted and/or received utilizing standard telecommunications protocol or standard networking protocol. In the preferred embodiment, the system utilizes Transmission Control Protocol/Internet Protocol (TCP/IP) and the network is a local area network. Other examples of protocols for transmitting and/or receiving data include but are not limited to Voice Over IP (VoIP) protocol, Short Message Service (SMS), and Global System for Mobile Communications (GSM). The network is capable of utilizing one or more protocols of computing device 100. Furthermore, the network can translate to or from other protocols to one or more protocols of computing device 100. As a result, a user can seamlessly transition from one computing device to another and continue to utilize the social media experiential platform.

FIG. 1 depicts a user experience during an event at venue/event subscriber 500 of the social media printing platform. Computing device 100 is preferably a smartphone but can comprise any personal electronic device, including but not limited to a mobile telephone, cellular telephone, smart watch, laptop computer, netbook, personal digital assistant (PDA), tablet, or any other computing device suitable for network communication and digital image capture, including devices currently manufactured as well as devices manufactured in the future that accomplish similar goals and operations. During the event, a user captures digital images utilizing computing device 100. Computing device 100 can communicate over a network to print the digital images captured utilizing module 200.

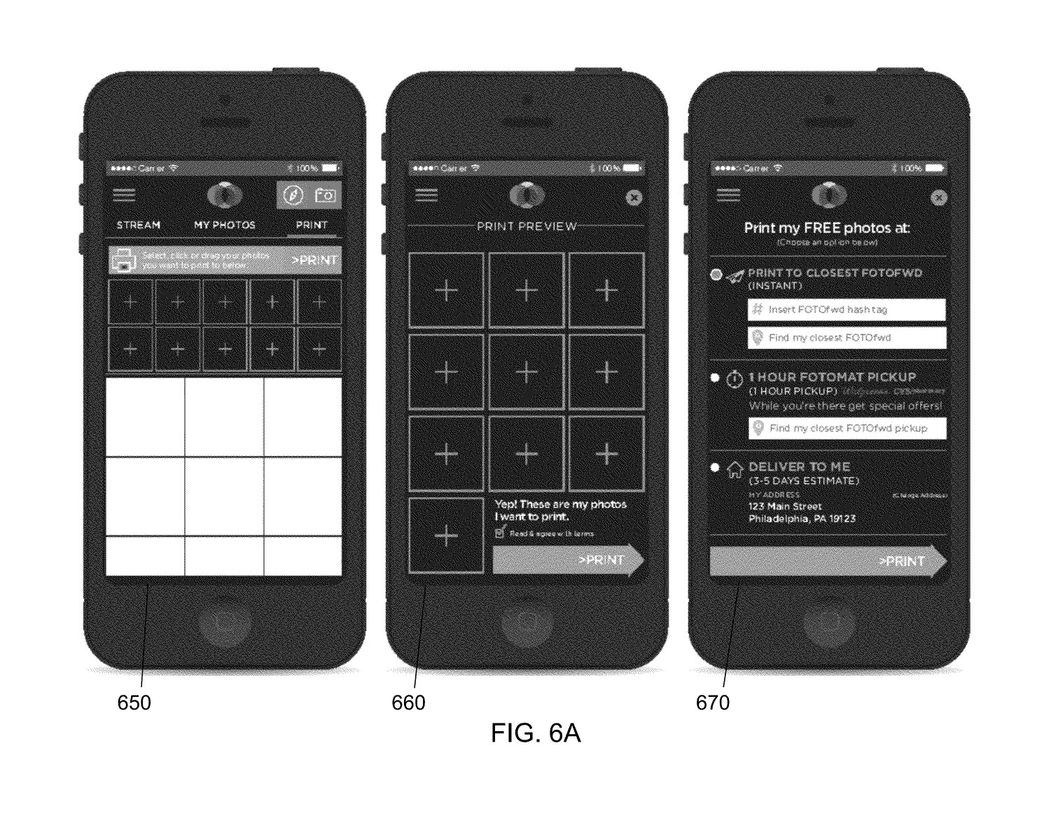

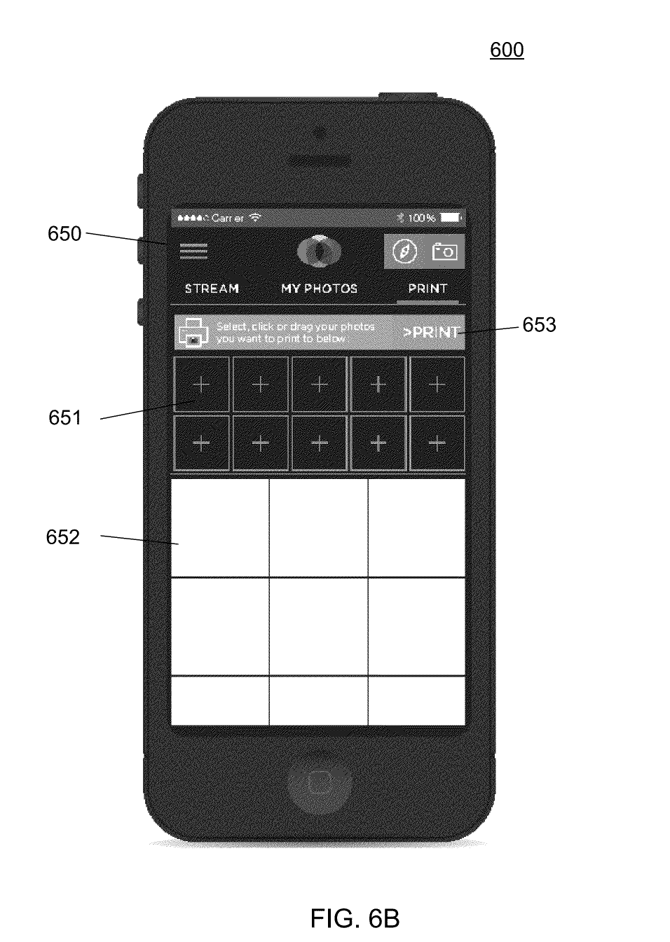

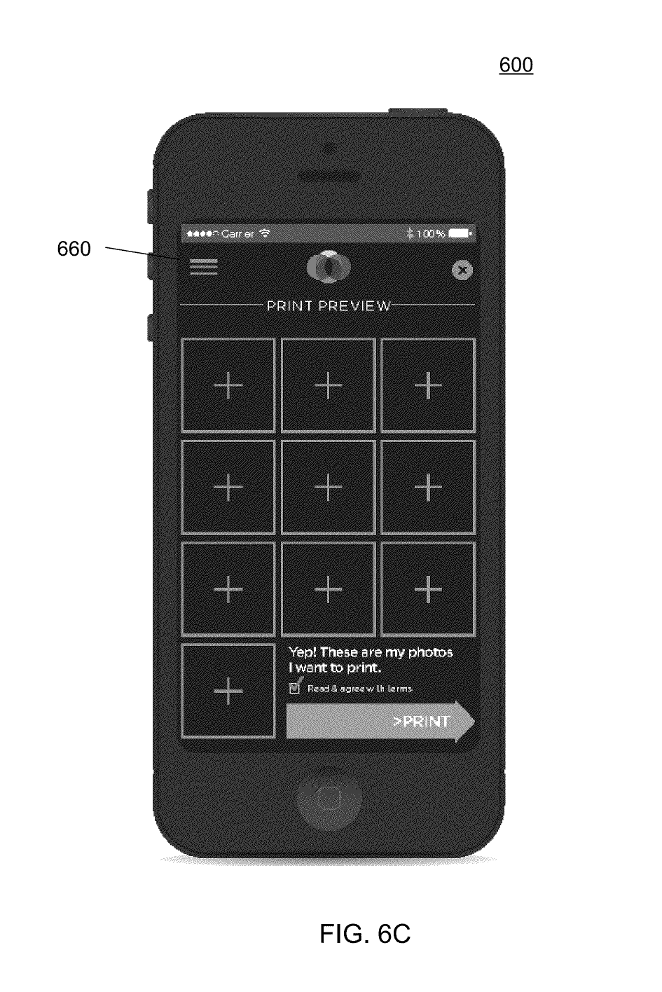

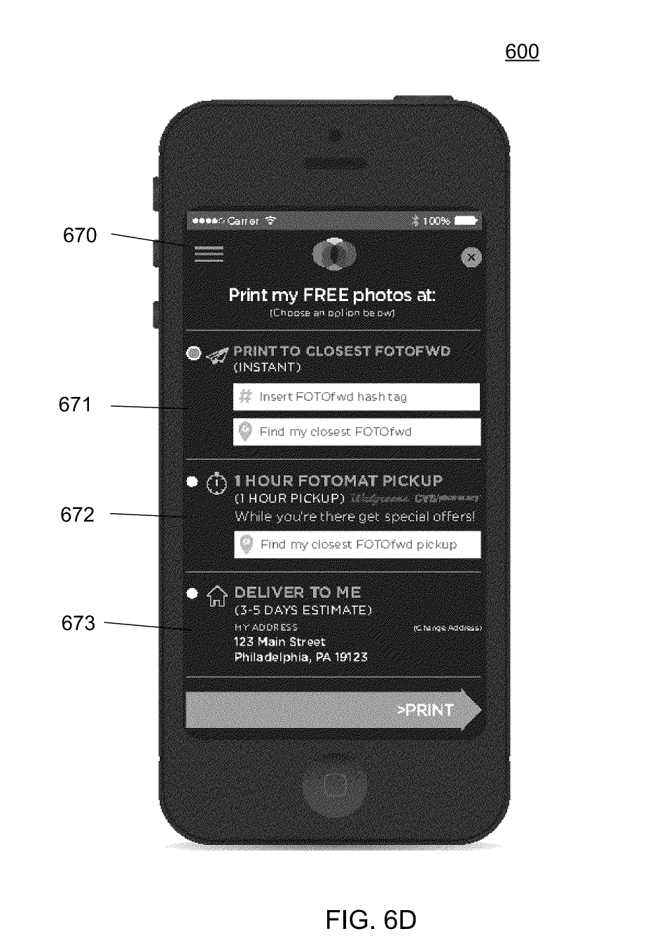

In the preferred embodiment, module 200 prints a photo of a user-selected digital image at no cost to the user for printing the photo. Module 200 is preferably Wi-Fi connected and hot spot enabled. Computing device 100 can communicate with module 200 utilizing a common network to which computing device 100 and module 200 are connected, or computing device 100 can communicate utilizing the hot spot network established by module 200. Software updates are preferably pushed to module 200 from the social media experiential platform. Further, module 200 comprises an interactive touchscreen display to allow a user to select digital images captured on computing device 100 to print. As described below in detail with reference to FIGS. 6A-6D, the user can also select the digital images to print utilizing computing device 100. Thereafter, module 200 prints photo 300 which comprise the user selected digital image. Module 200 preferably utilizes inkless printing and comprises a refillable photo paper supply. Photo 300 comprises digital image 302 and print sponsor banner 304. In addition, a user can direct the social media experiential platform to post a digital image to social media provider 400.

The social media experiential platform preferably allows venue/event subscriber 500 to generate social media awareness, visibility, brand affiliation, and promotion at no cost to venue/event subscriber 500 for the printing material of module 200. When a user utilizes the social media printing platform to post a digital image to social media provider 400, tags are included with the post to promote the venue/event subscriber. For example, the tags can include the name of the event and the location of the venue. The tags can also include the name of a sponsor and/or a sponsor message. Furthermore, print sponsor banner 304 of photo 300 can include tags to promote venue/event subscriber 500 and/or a sponsor. In the preferred embodiment, the sponsor pays the costs for the printing material of module 200. The social media experiential platform selects the sponsor to promote on the posted and/or printed digital image based on information about venue/event subscriber 500, events attended by the user, and the sponsor's targeted demographic. For example, a user that posts and/or prints digital images during a music event utilizing the social media experiential platform can receive tags from sponsors associated with the music event. Venue/event subscriber 500 can also include information on the targeted demographic of the event for the social media experiential platform to utilize when selecting a sponsor.

The social media experiential platform provides several advantages to venue/event subscriber 500 and sponsors. A venue/event subscriber 500 that includes a module 200 preferably pays a recurring monthly fee to the social media experiential platform. In turn, venue/event subscriber 500 can benefit from a differentiated customer experience that provides digital photo printing at no cost to the customer. Further, venue/event subscriber 500 gains enhanced social media presence through tags automatically included in posts to social media providers utilizing the social media experiential platform. Also, the social media experiential platform provides analytics on a digital image. Examples include the number of reposts, positive feedback, and number of times printed. Furthermore, the social media experiential platform aggregates the digital images captured at an event for venue/event subscriber 500 to later view. As described above, sponsors pay the costs of the printing material of module 200. In turn the sponsors can target a specific audience and receive measurable demographic usage and reporting from the social media experiential platform.

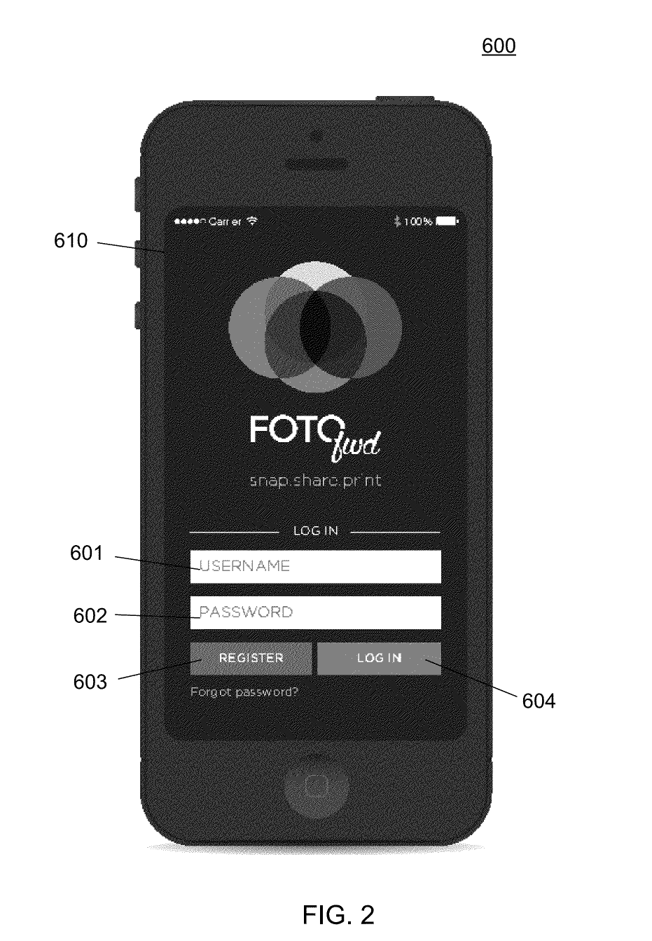

FIGS. 2-5, 6A-6D, 7A-7D, 8, 9A-9D illustrate computing device 600 running software in accordance with the preferred embodiment of the present invention. As shown in FIG. 2, user interface 610 prompts a user to log into a user profile. The user profile stores information including but not limited to user settings, photos, photo orders, preferred print options, and events attended. User interface 610 comprises various user selectable interface elements, including but not limited to username input 601, password input 602, and log in button 604. A user can register for a new user profile by pressing register button 603.

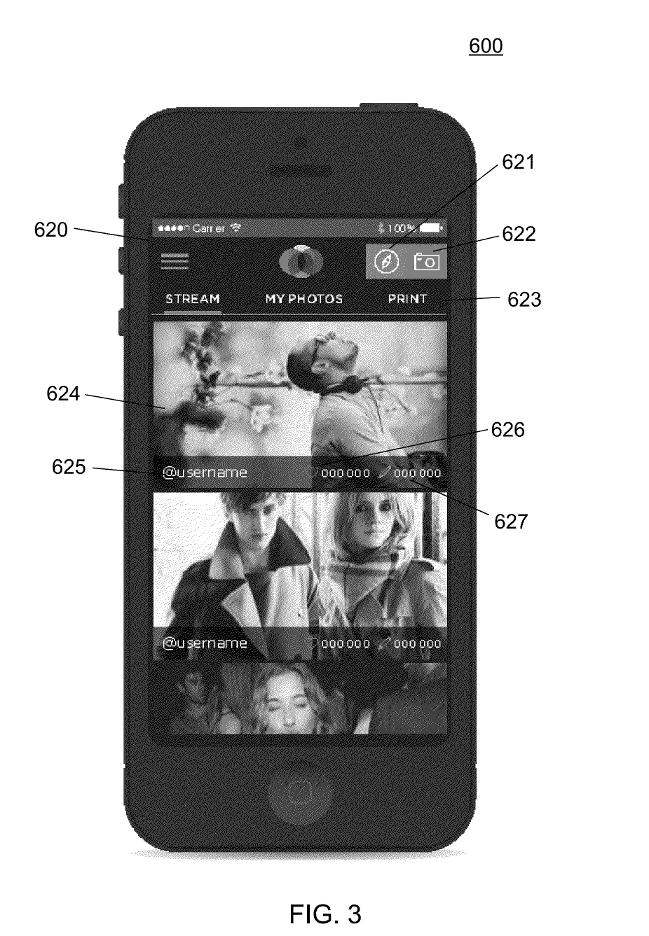

Turning next to FIG. 3, the user is shown user interface 620 after accessing the user's profile. During an event, the user is prompted to join the network of the event the user is attending. The network can either be set up by the venue or a hot spot set up by a module, for example, module 200 described in detail above with reference to FIG. 1. User interface 620 preferably includes location button 621 and camera button 622. Location button 621 provides access to geolocation software on computing device 600. Camera button 622 provides access to digital image capture software on computing device 600. Navigation to various user interfaces of the software is provided by menu 623. Menu 623 preferably provides access to a stream user interface, photos user interface, and print options user interface. As shown in FIG. 3, user interface 620 depicts the stream user interface. The stream user interface displays a plurality of digital image thumbnail views 624. Each digital image thumbnail view 624 includes username 625 of the user that captured the digital image. Further, digital image thumbnail view 624 includes feedback indicator 626 and comments indicator 627. In the preferred embodiment, feedback indicator 626 displays the number of unique users that have indicated positive feedback to the digital image. Comments indicator 627 displays the number of comments posted about the digital image by unique users. During an event, the stream user interface preferably displays the digital images taken and posted by users at the event. As a result, a user can have access to all of the digital images captured at the event. In some embodiments, the stream user interface displays the digital images with either the most comments or positive feedback.

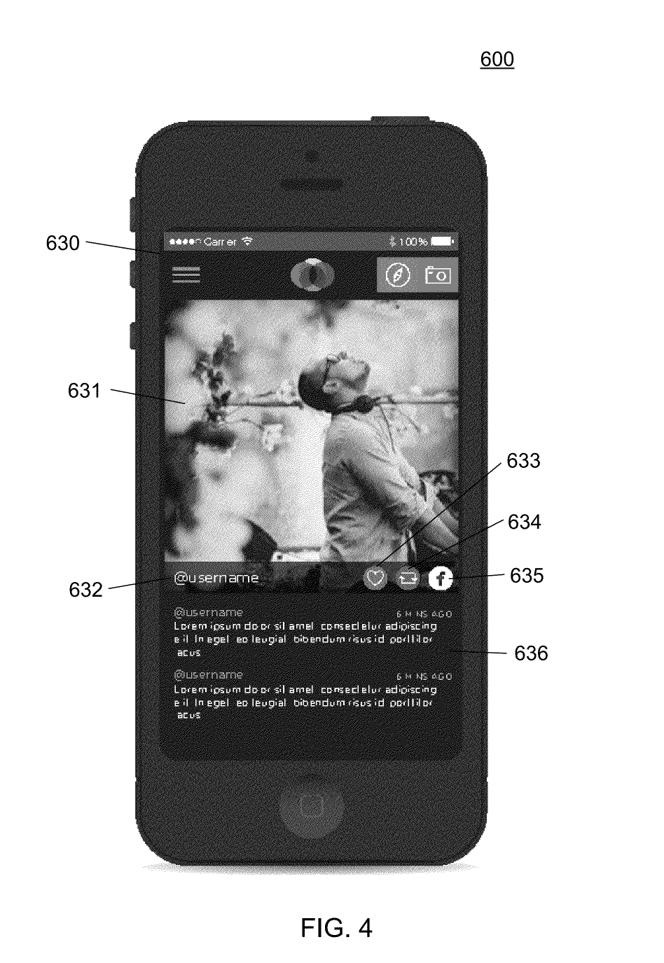

FIG. 4 depicts user interface 630 which is shown to a user after the user selects a digital image shown in user interface 620. User interface 630 preferably includes digital image view 631, username 632, feedback indicator 633, repost indicator 634, source indicator 635, and comments area 636. Digital image view 631 provides a full image preview of the digital image selected in user interface 620. A user preferably selects feedback indicator 633 to indicate that they like the digital image. Users can also repost the digital image to their social media provider accounts by selecting repost indicator 634. Source indicator 635 preferably directs the user to the source of the digital image for the user to view and/or store on the user's computing device. As shown in FIG. 4, the source of the digital image is Facebook®, however source indicator 635 can represent other social media provider icons. Comments about the digital image are displayed in comments area 636. The comments are preferably made by other users of the social media experiential platform. However, in some embodiments, the comments shown are from the social media providers where the digital image is posted.

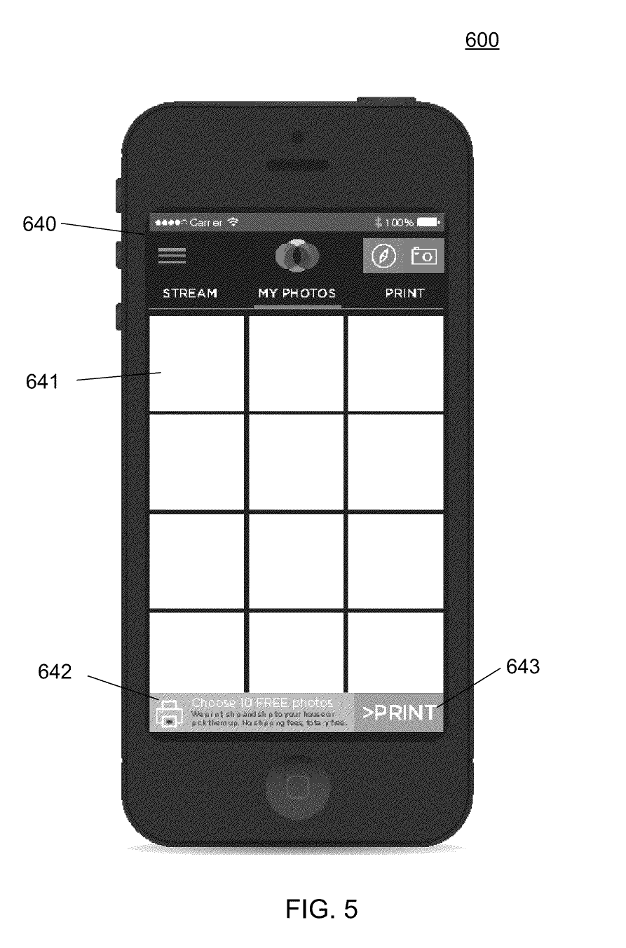

Shown in FIG. 5, user interface 640 comprises a plurality of digital image thumbnail views 641. Digital image thumbnail views 641 depict the digital images stored on computing device 600 and the digital images posted to the user's social media provider accounts. User interface 640 permits a user to select the digital images to post to social media provider account(s) or print as described in detail below with reference to FIGS. 6A-6D. Print sponsor banner 642 depicts offers from a sponsor that will cover the costs associated with printing the digital image. Print sponsor banner 642 can include a message from a sponsor. User interface 640 can also include a print button 643 to allow the user to print one or more digital images selected.

FIGS. 6A-6D depicts the user experience of utilizing a common interface to select digital images to print and the available print options. As shown in FIG. 6A, the user selects the digital images to print in user interface 650. A plurality of digital image thumbnail views 652 allow a user to select the digital images to print. A preview of each selected digital image to print is displayed on a plurality of print preview views 651. After selecting the digital images to print, the user can press print button 653 to continue.

Next, in user interface 660, the user is prompted to confirm the selected digital images to print. Finally, in user interface 670, the user selects the available options to print the digital images. In the preferred embodiment, a user can select option 671 to print the digital image at the nearest social media printing platform module. Option 672 allows the user to print the digital image at a retail location and option 673 allows the user to have the print of the digital image delivered to an address via mail. The social media experiential platform automatically translates the user's selected digital images to a format that each printing option utilizes. As a result, a user can use a unified interface for printing to various different printing options.

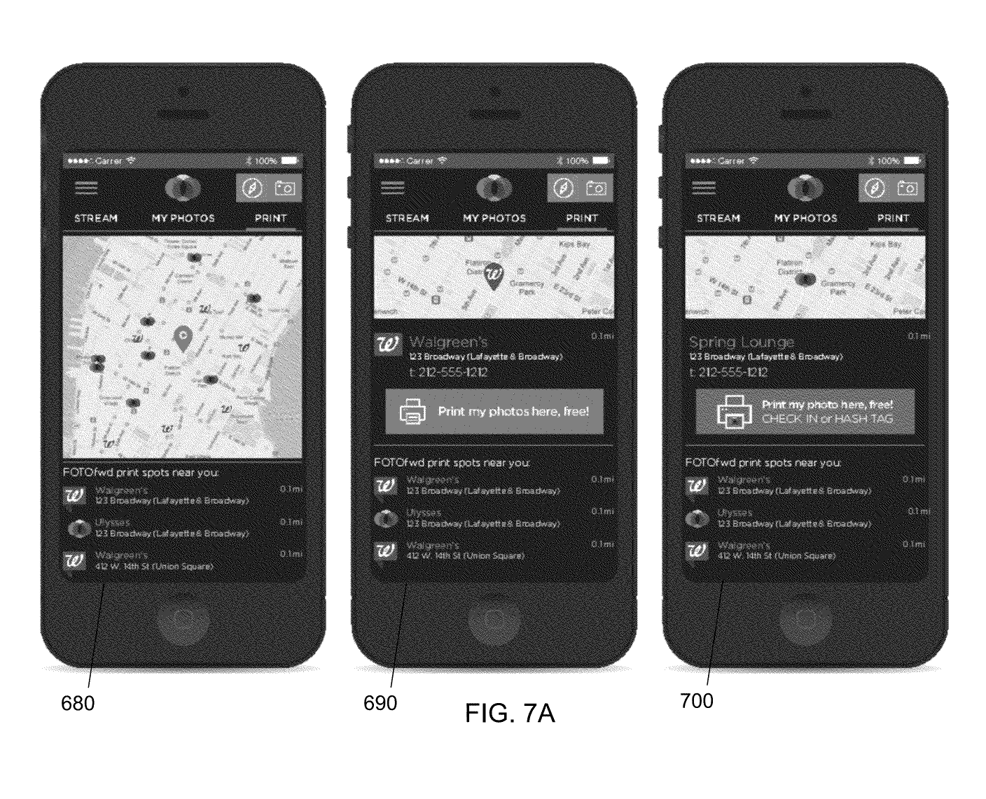

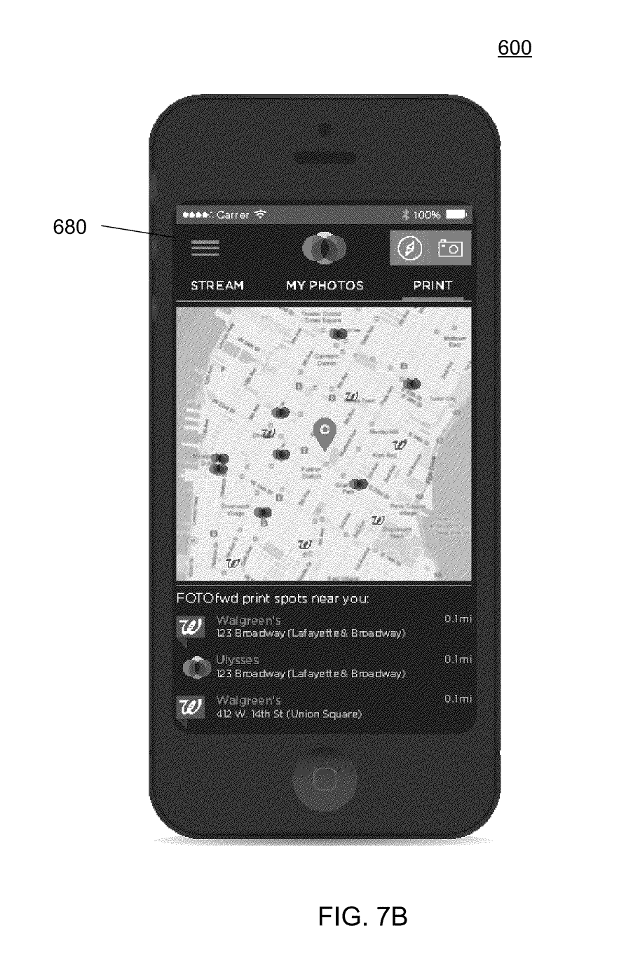

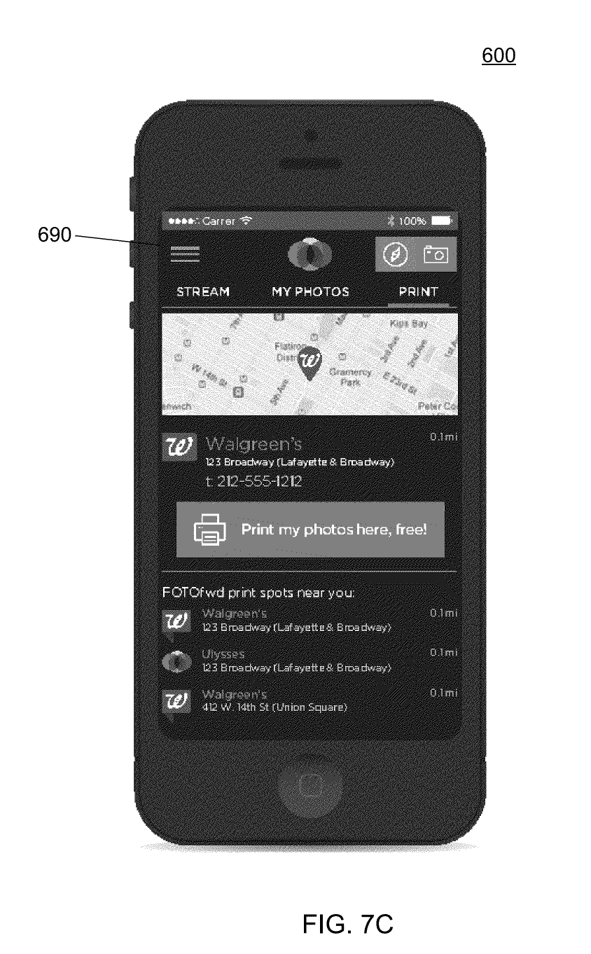

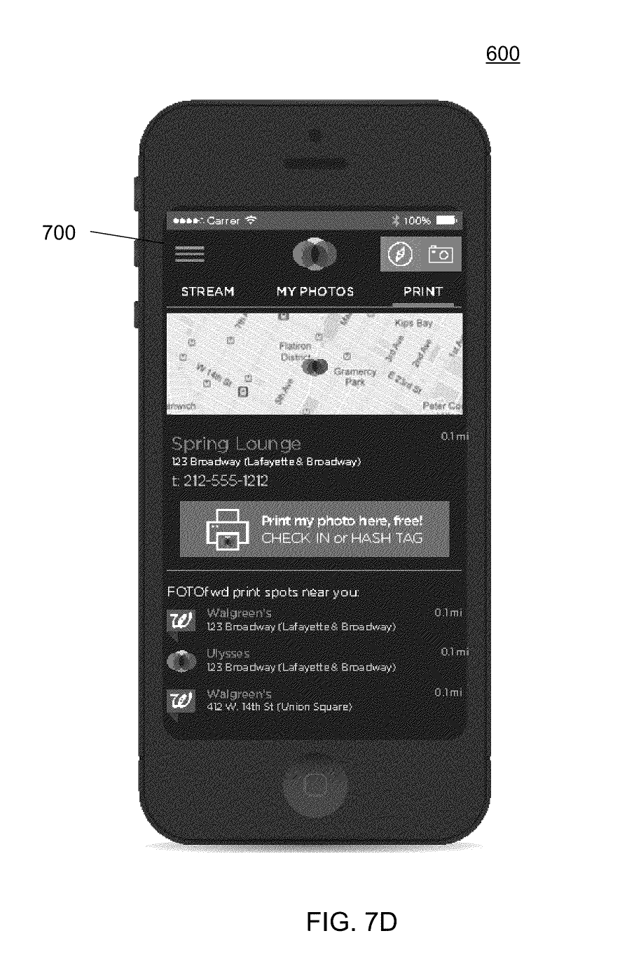

FIGS. 7A-7D depicts the user experience of selecting kiosk and/or retail locations to print the selected digital images. As shown in FIG. 7A, user interface 680 displays print locations near the user using geolocation software on computing device 600. User interface 690 in FIG. 7B depicts the user selecting a retail location, while user interface 700 depicts the user selecting a kiosk location.

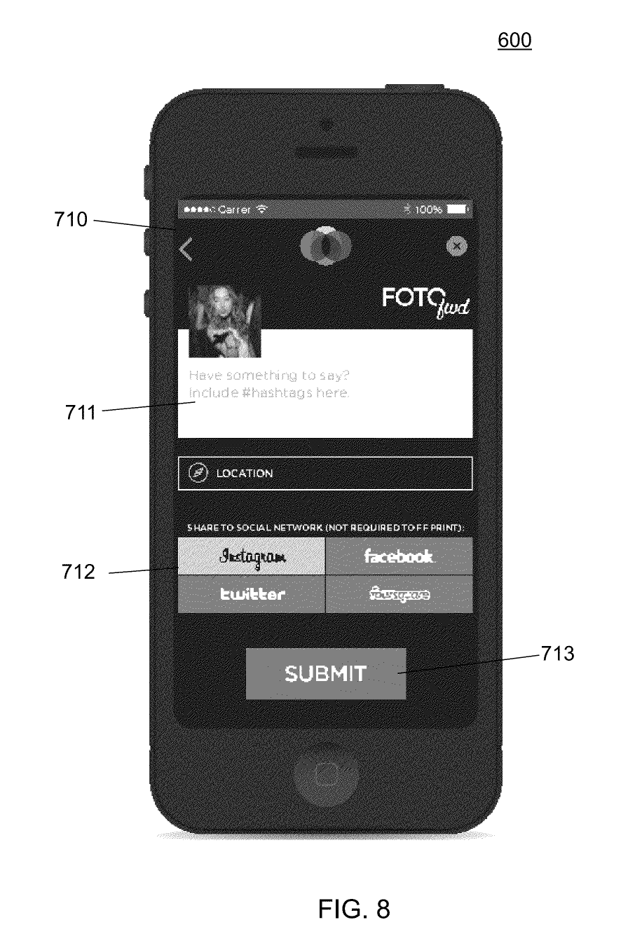

In addition to providing a unified interface to print digital images to various retail and kiosk locations, a user is enabled to post digital images to a social media provider utilizing a common interface. As shown in FIG. 8, user interface 710 comprises message area 711, social network provider area 712, and submit button 713. A preview of the digital image to post is shown in message area 711. Further, the user can insert a message to include in the post. In some embodiments, the message area is automatically populated with tags related to the event that the digital picture was captured. Further, the tags can include sponsor messages. Social network provider area 712 displays a list of social network providers that the user can select to post the digital image. The user selects submit button 713 to post the selected digital image and message to one or more social network providers. The social media experiential platform automatically translates the user's selected digital image and message to a format that each social media provider utilizes. As a result, a user can use a single interface for posting digital images to various social network providers.

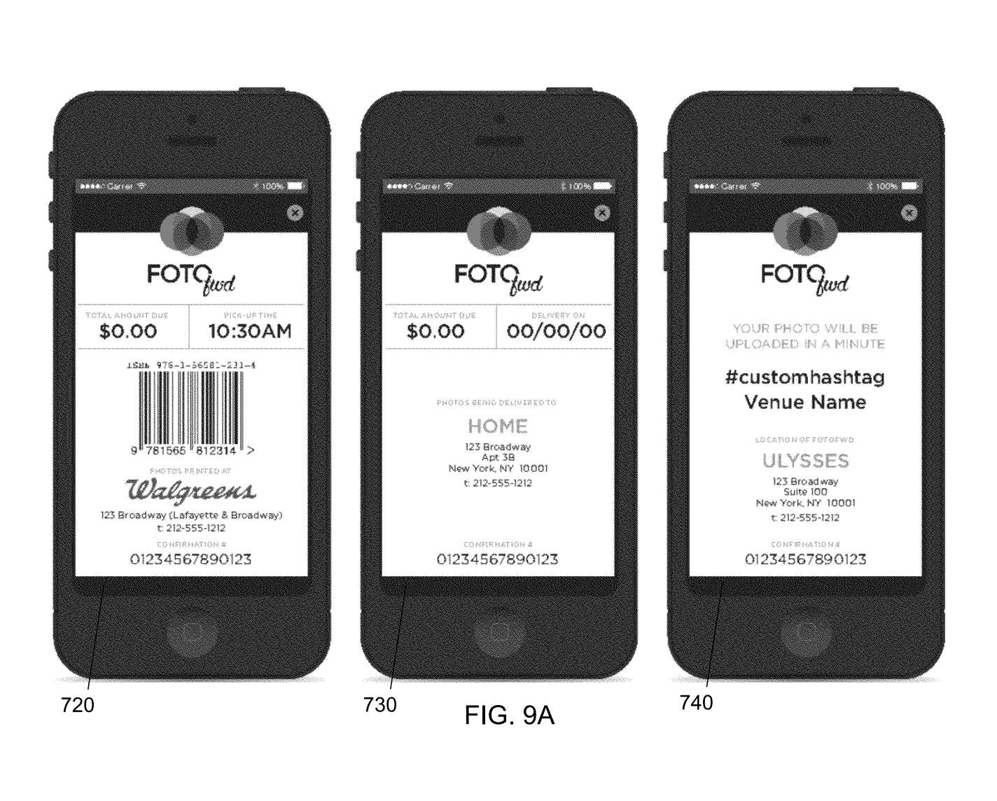

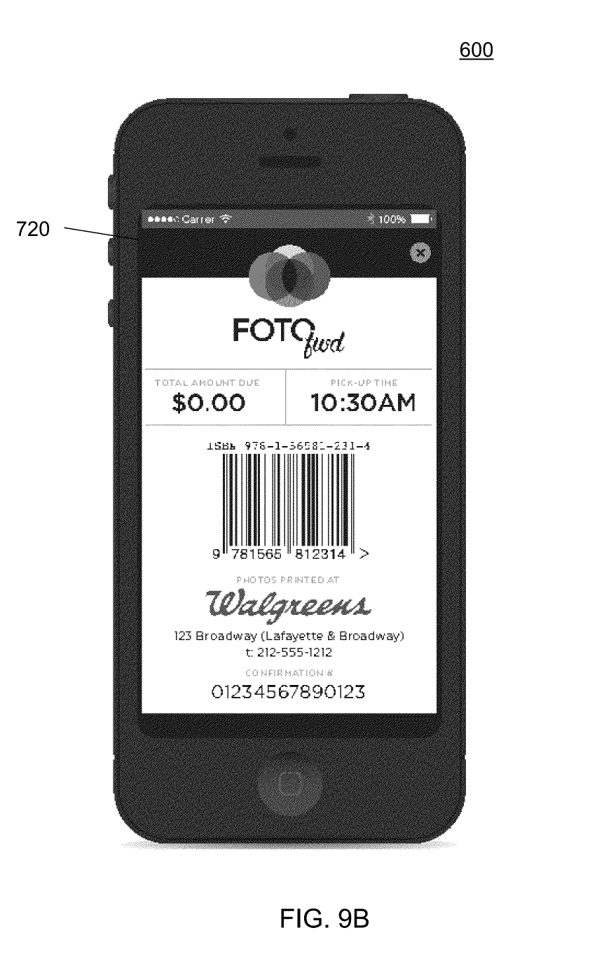

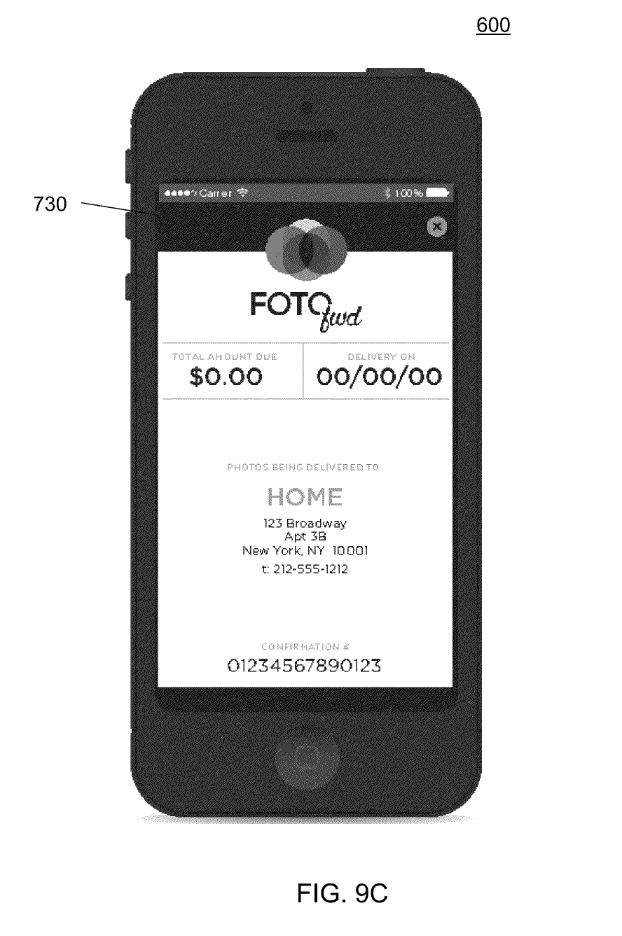

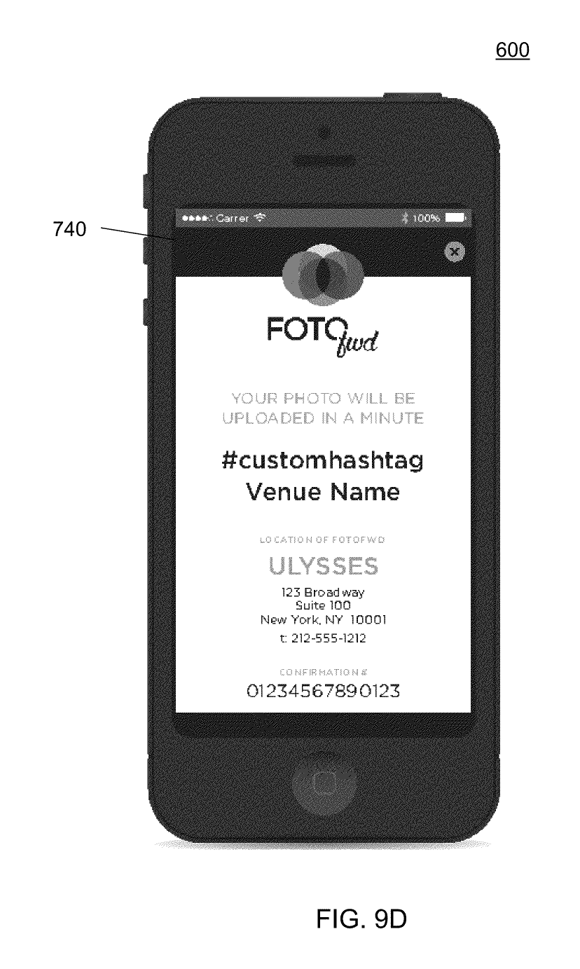

FIGS. 9A-9D depicts the user interfaces that depict confirmation of the user's completed print order. As shown in FIG. 9A, user interface 720 depicts a confirmation for the digital image being printed to a retail location. The confirmation can include information about the location of the retail location and time that the digital images will be ready. As shown, there is no cost to the consumer for printing the digital image. User interface 730 depicts a confirmation for the digital image being printed and mailed to the user's home. The confirmation can include information on the expected delivery date and the delivery address of the printed digital images. Once again there is no cost to the consumer for having the printed digital images mailed to the user's home. Finally, user interface 740 depicts a confirmation for the digital image being printed to a kiosk and posted on the user's selected social media providers.

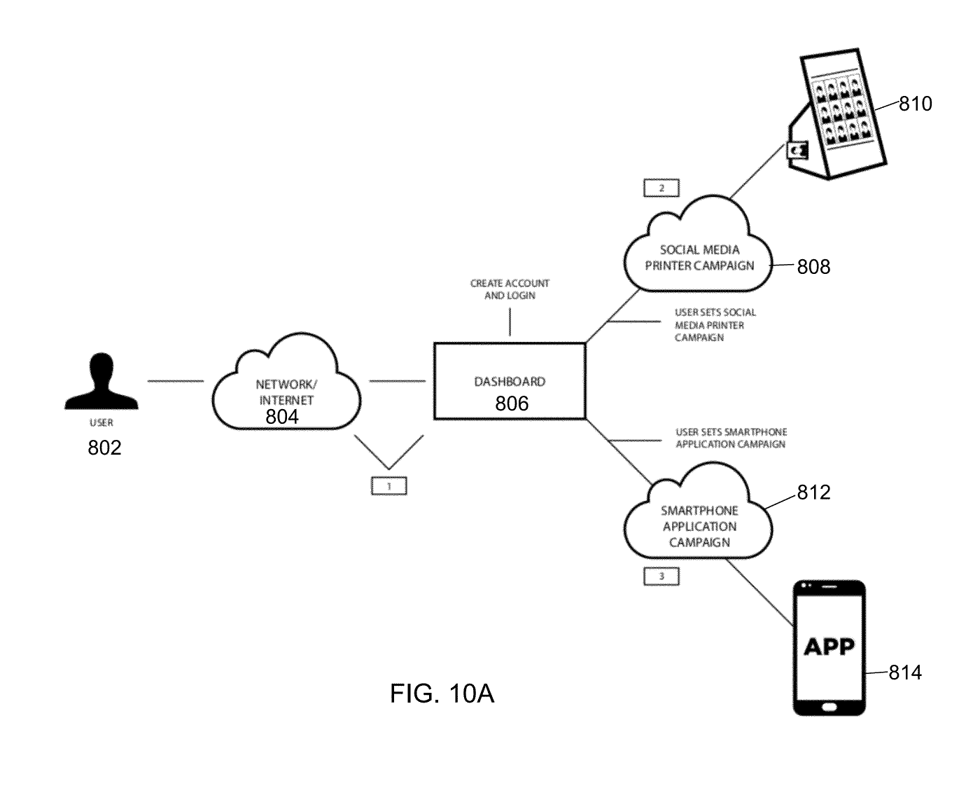

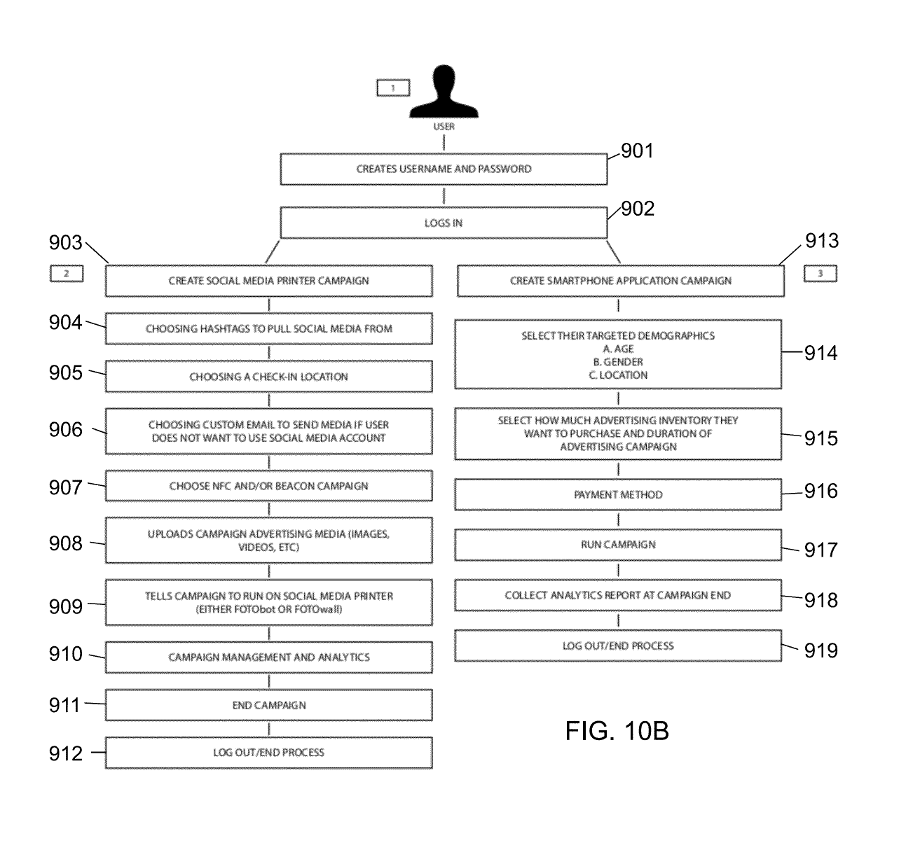

FIGS. 10A-10B depict an embodiment of the process that a venue/event subscriber utilizes the social media experiential platform to generate social media awareness, visibility, brand affiliation, and promotion. As shown in FIG. 10A, venue/event subscriber 802 communicates over a network 804 to access dashboard 806 of the social media experiential platform. In this embodiment, venue/event subscriber 802 can configure a social media printer campaign 808 and/or a smartphone application campaign 812 through dashboard 806. Social media printer campaign 808 allows venue/event subscriber 802 to provide printed photographs of digital images taken during an event at module 810. Smartphone application campaign 812 allows venue/event subscriber 802 to provide targeted marketing on computing device 814.

FIG. 10B depicts the process performed by a venue/event subscriber to configure a social media printer campaign and/or a smartphone application campaign. In step 901, the subscriber is prompted to create a user profile or enter the user's account information, such as a username and password associated with the subscriber's profile stored on the social media experiential platform. Next in step 902 the subscriber logs in. To configure a social media printer campaign the subscriber follows step 903 through step 912. In step 904 the subscriber selects tags to pull social media from. Thereafter in step 905, the subscriber selects a venue to run the social media printer campaign. In step 906, the user can select a custom e-mail address. The custom e-mail address allows a user attending the venue to e-mail media to the social media experiential platform without a user profile stored on the social media experiential platform. Next in step 907, the subscriber can configure whether computing devices at the venue selected in step 905 can connect to the social media experiential platform using near field communication or a beacon. An exemplary beacon includes a Bluetooth beacon. In step 908, the subscriber uploads the advertising media that will be used in the social media printer campaign. The media uploaded in step 908 is transmitted to a social media printer to include with photos printed. An exemplary social media printer includes the module described above with reference to FIG. 1. Yet another exemplary social media printer includes an interactive photo touch wall with printing capabilities. Next in step 910, the subscriber manages the campaign (i.e. adjust updated media) and receives analytics from the social media experiential platform. After the campaign ends in step 911, the subscriber can logout and end the process in step 912.

To configure a smartphone application campaign the subscriber follows step 913 through step 919. In step 914, the subscriber selects a target demographic for the smartphone application campaign. Exemplary criteria for the demographic include age, gender, and location. Next in step 915, the subscriber configures the duration of the advertising campaign and inventory. Thereafter, a payment method is selected in step 916 for the advertising campaign. In step 917, the smartphone application campaign is initiated on the social media experiential platform. Computing devices that are operating an application configured to communicate with the social media experiential platform are presented with targeted advertisements based on the criteria selected in step 914 and the user profile on the social media experiential platform associated with the computing device. In step 918, the subscriber receives analytics on the computing devices that viewed the smartphone application campaign. Finally in step 919 the process ends and the subscriber can logout.

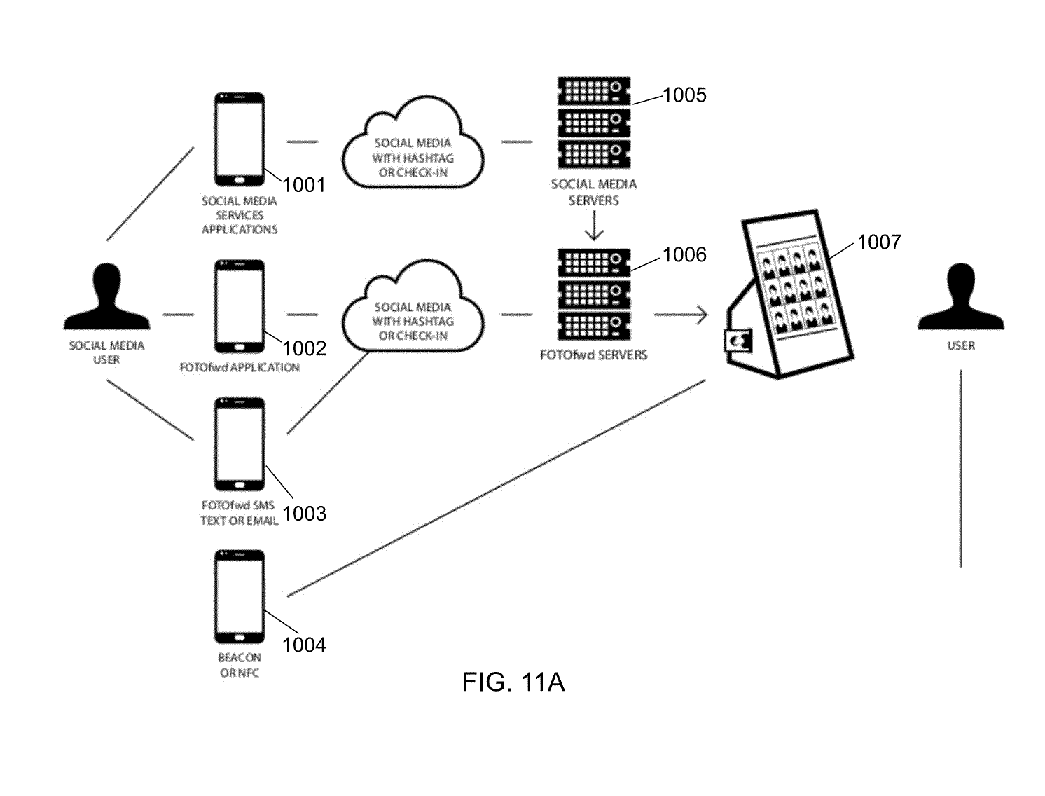

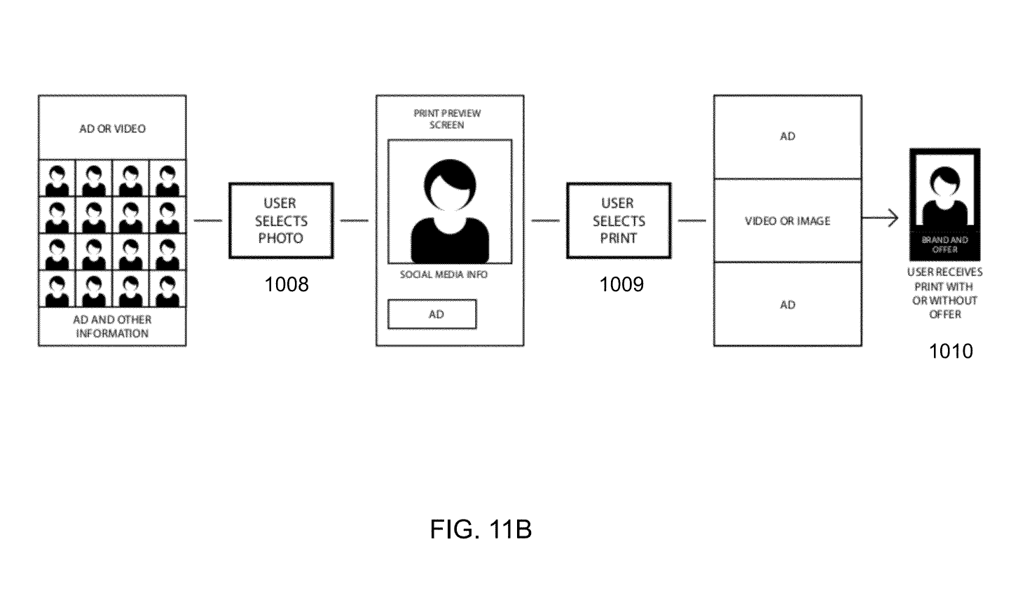

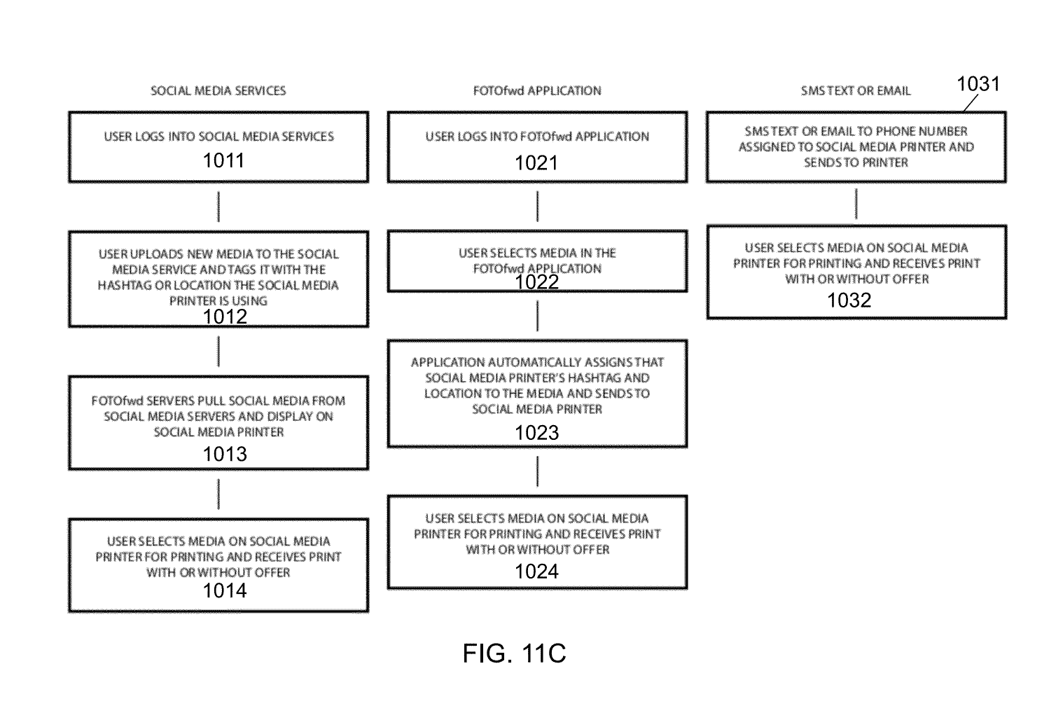

FIGS. 11A-11C depict an exemplary interaction of a social media user with the social media experiential platform at a venue. Turning first to FIG. 11A, a social media user can interact with the social media experiential platform utilizing various interfaces on a computing device. Interface 1001 of the computing device utilizes the social media user's social network providers. In this embodiment, interface 1001 communicates with social network provider 1005 to transmit media with tags. Social media experiential platform 1006 scrapes the publically available data from social network provider 1005 for tags. The tags to scrap are preferably configured by the venue/event subscriber. Interface 1002 utilizes an application configured to communicate with the social media experiential platform. In this embodiment, the application automatically includes a tag and location to the media transmitted to social media experiential platform 1006. Interface 1003 utilizes Short Message Service (SMS) text or e-mail. The social media user can send media to social media experiential platform 1006 utilizing a unique SMS text number or e-mail address provided by social media experiential platform 1006. In this embodiment, the phone number and e-mail address provided by social media experiential platform 1006 is automatically associated with tags. Finally, interface 1004 utilizes near field communication and/or a beacon. In this embodiment, the computing device includes near field communication and/or beacon capabilities. The social media user can tap an interface button to transmit media to social media printer 1007 to print a photograph. Social media printer 1007 can automatically include tags associated with the media transmitted from the computing device. As shown in FIG. 11A, social media experiential platform 1006 transmit media to social media printer 1007 to print a photograph.

FIG. 11B depicts an exemplary process for printing media at social media printer 1007 (shown in FIG. 11A). In step 1008, the social media user selects a photo from preferably a screen on social media printer 1007. The interface to select a photo can include an advertisement banner at the top or bottom and a plurality of digital images. Next in step 1009, the social media user confirms the digital image to print after viewing a print preview. Finally in step 1010, social media printer 1007 (shown in FIG. 11A) prints a photograph of the digital image with or without an offer.

FIG. 11C depicts an exemplary process for printing digital images from a user's social network providers, printing digital images captured on a user's computing device using an application that communicates with the social media experiential platform, and a user texting or e-mailing a digital image to print. The process of printing digital images uploaded to a user's social network provider begins in step 1011 with the user connecting to their social network provider. Next in step 1012, the user uploads new media to their social network provider. The new media can include tags or a location provided by the social network provider at the event. In step 1013, the social media experiential platform pulls the media uploaded to the user's social network provider utilizing the tags associated with the media. Thereafter the social media experiential platform transmits the media pulled to the social media printer. Finally in step 1014, the user selects the digital image to print on the social media printer and receives a photograph with or without an offer.

The process of printing a digital image using an application that communicates with the social media experiential platform begins in step 1021 with the user logging into their user profile stored on the social media experiential platform via the application. The social media experiential platform can provide tags and a location to the application based on the event that the user indicates that they are attending. In step 1022, the user selects media to transmit utilizing the application. Next in step 1023, the application automatically assigns tags and a location associated with the social media printer at the event. Thereafter, the media is transmitted to the social media printer. Finally in step 1024, the user selects the digital image to print on the social media printer and receives a photograph with or without an offer.

The process of sending digital images to print utilizing SMS text or an e-mail begins in step 1031 with the social media experiential platform assigning a unique phone number or unique e-mail address. The unique phone number or unique e-mail address is assigned to a social media printer. Next in step 1032, the user sends a SMS text or e-mail comprising a digital image to the unique phone number or unique address. In turn, the social media experiential platform can e-mail or text an offer to the user. The social media printer prints a photograph of the digital image which can contain an offer.

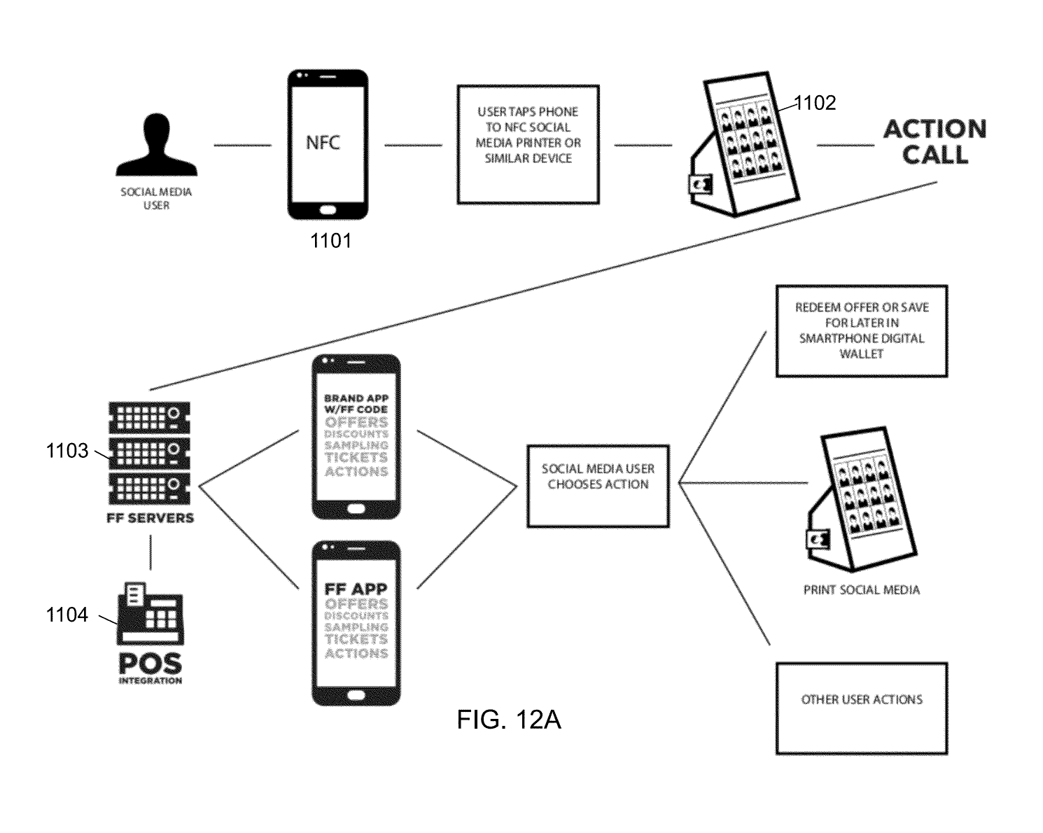

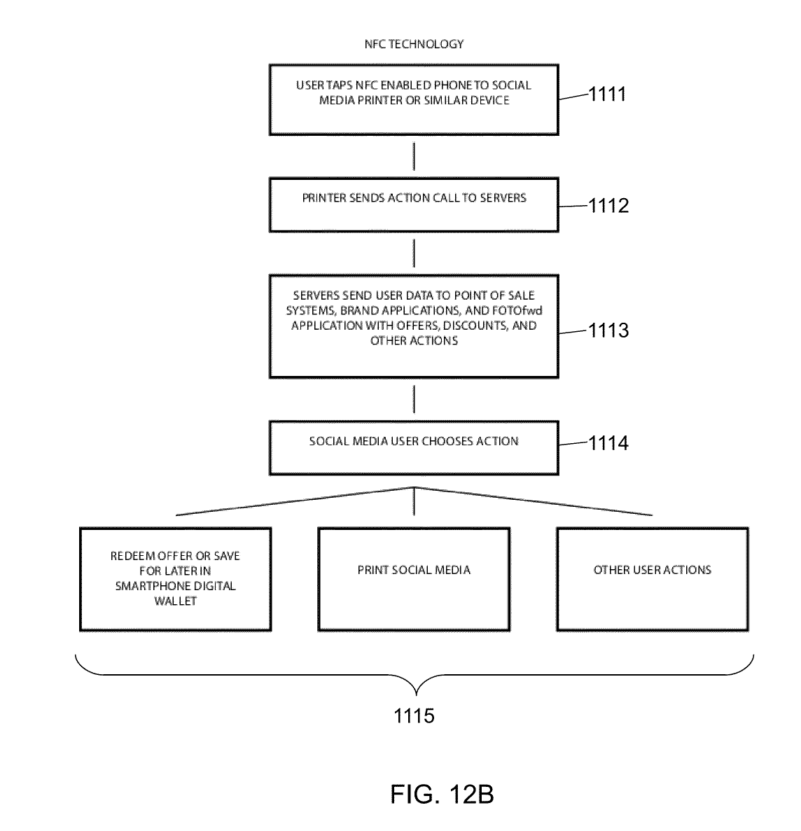

FIGS. 12A-12B depict an exemplary interaction of a social media user with the social media experiential platform at a venue utilizing near field communication. In step 1111, the social media user utilizes computing device 1101 (shown in FIG. 12A) to communicate with a social media printer 1102 using near field communication. Social media printer 1102 can be the module described in detail above with reference to FIG. 1 or an interactive photo touch wall with printing capabilities. In step 1111, the communication is initiated by the social media user tapping computing device 1101, but in other embodiments the communication can automatically occur based on the proximity of computing device 1101 to social media printer 1102. Next in step 1112, social media printer 1102 (shown in FIG. 12A) communicates with social media experiential platform 1103. Next in step 1113, social media experiential platform 1103 communicates with point of sale system 1104 (shown in FIG. 12A) to determine the offers, discounts, and other actions to provide to the social media user on computing device 1101. Other actions that can be presented to the user include surveys or a contest entry. Thereafter in step 1114, the social media user selects from the offers, discounts, and other actions selected in step 1113. In this example, the social media user in step 1115 can select to redeem an offer, save the offer, print the social media, or another action.

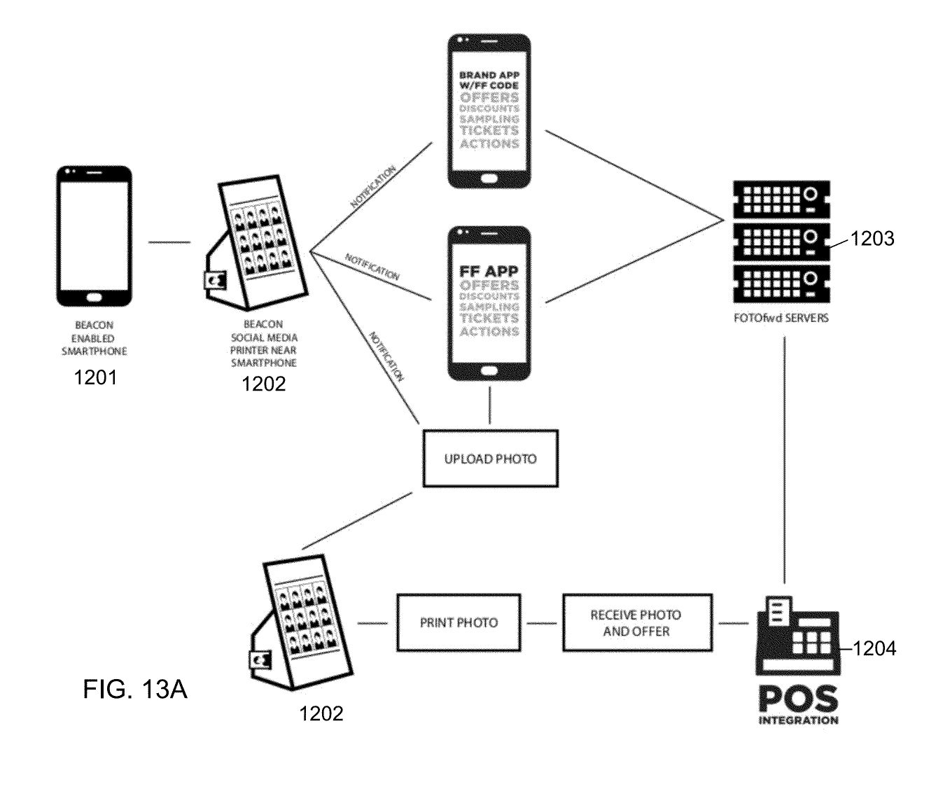

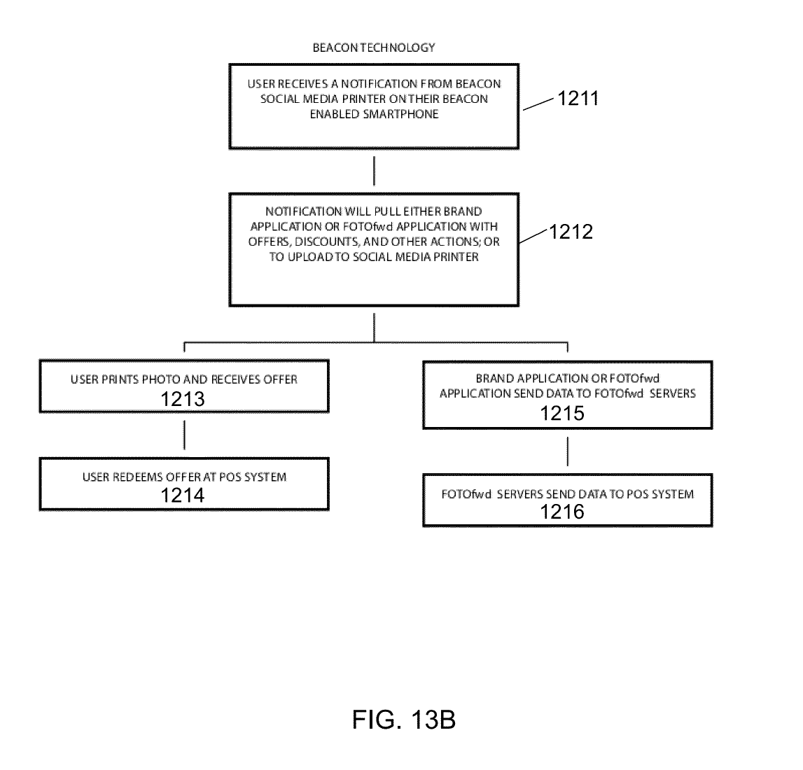

FIGS. 13A-13B depict an exemplary interaction of a social media user with the social media experiential platform at a venue utilizing a beacon. An exemplary beacon is a Bluetooth beacon. In step 1211, computing device 1201 (shown in FIG. 13A) receives a notification from social media printer 1202. Computing device 1201 is preferably configured to communicate with a beacon and social media printer 1202 comprises a beacon. In step 1212, the notification comprises offers, discounts, and other actions to provide to the social media user. The offers, discounts, and other actions are selected by social media experiential platform 1203 communicating with point of sale system 1204. Further, an exemplary action includes allowing the social media user to upload a digital image to social media printer 1202 (shown in FIG. 13A). In step 1213, the user selects to print a digital image at social media printer 1202 and receives an offer. Next in step 1214, the user can redeem the offer received in step 1213 at point of sale system 1204. In step 1215, an application executing on computing device 1201 communicates user data with social media experiential platform 1203. In step 1216, the social medial experiential platform 1203 communicates with point of sale system 1204.

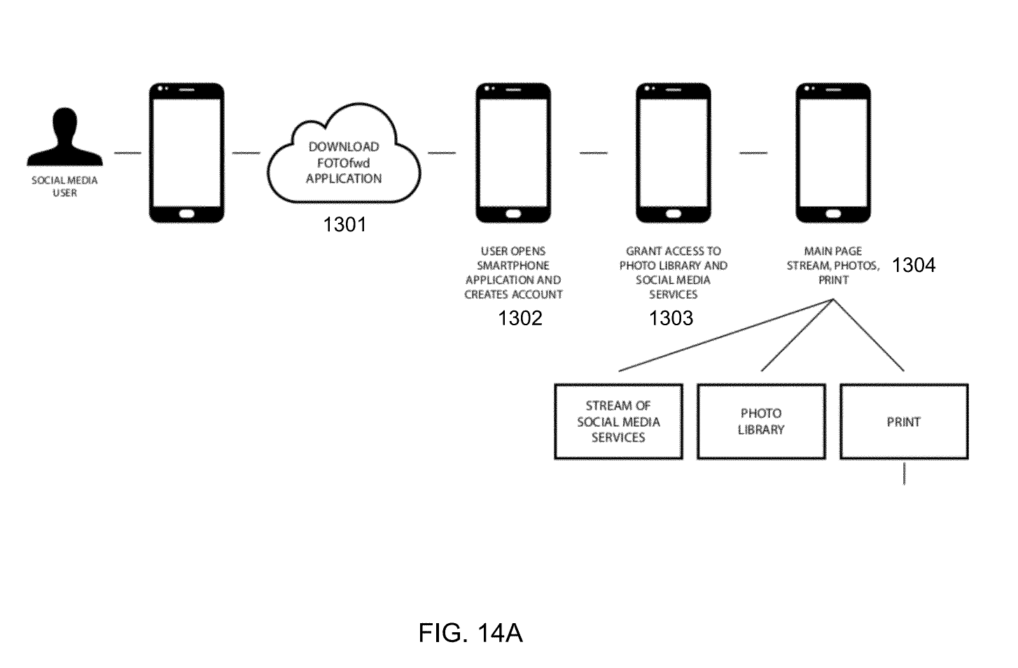

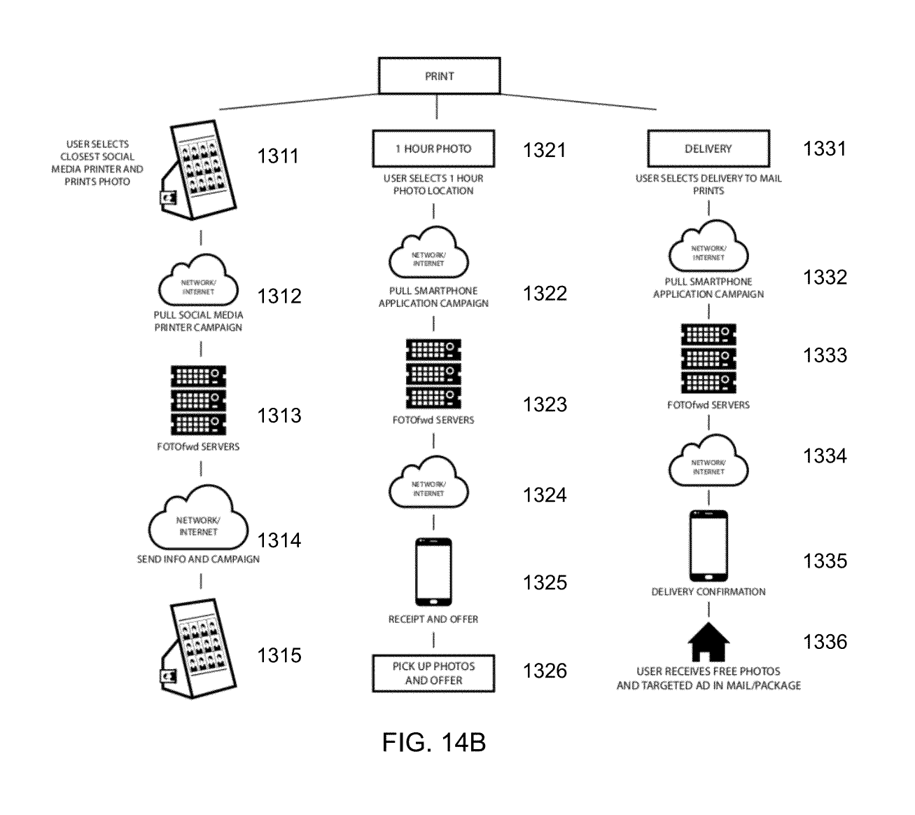

FIGS. 14A-14B depict an exemplary process of a social media user receiving a printed photograph of a digital image with an embodiment of the social media experiential platform at no cost to the social media user. As shown in FIG. 14A, the social media user downloads to a computing device an application with capabilities to communicate with the social media experiential platform. In step 1302, the user opens the application downloaded in step 1301 and creates a user profile if necessary. Further in step 1303, the user grants the application access to the photo library on the computing device and the user's social network provider accounts. Next in step 1304, the application downloaded in step 1301 displays a list of actions for the social media user. In this embodiment the actions include but are not limited to, viewing a photo library of digital images, printing a photograph of a digital image, and viewing an aggregation of posts from the social media providers selected in step 1303 in a unified interface. FIG. 14B depicts an exemplary process of the social media user receiving a printed photograph of a digital image. Step 1311 through step 1315 depict the process of printing the digital image at a social media printer. Step 1321 through step 1326 depict the process of printing a digital image at a retail location. Finally step 1331 through step 1336 depict an exemplary process of mailing a printed digital image to the social media user.

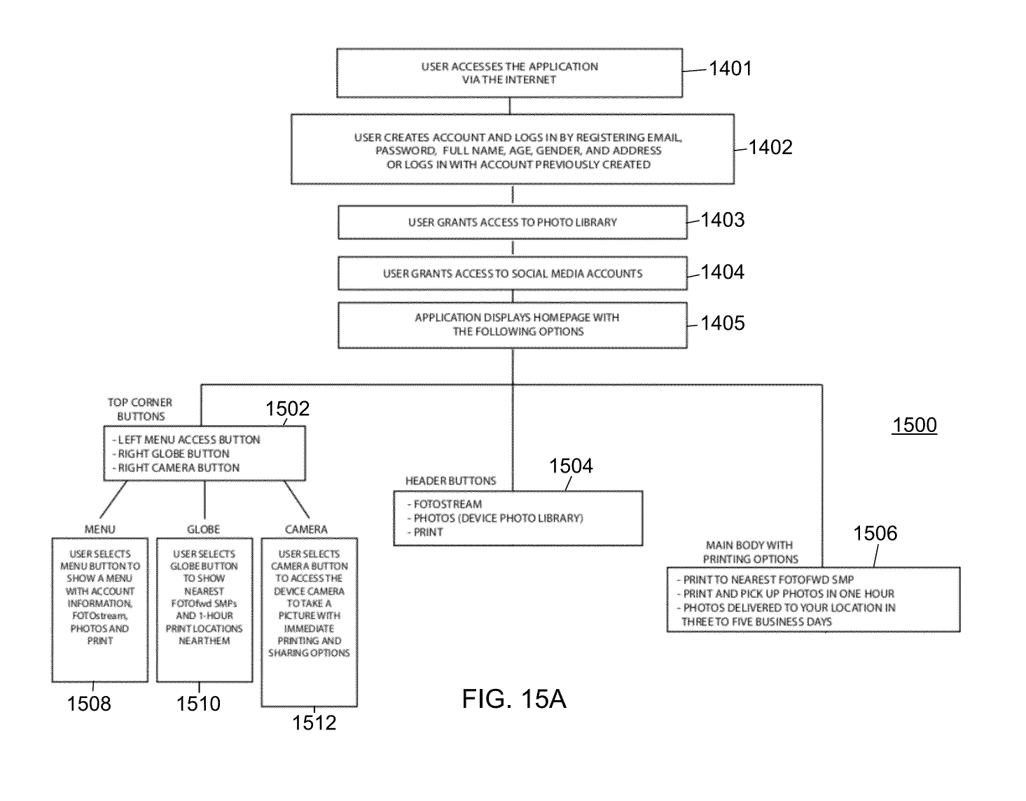

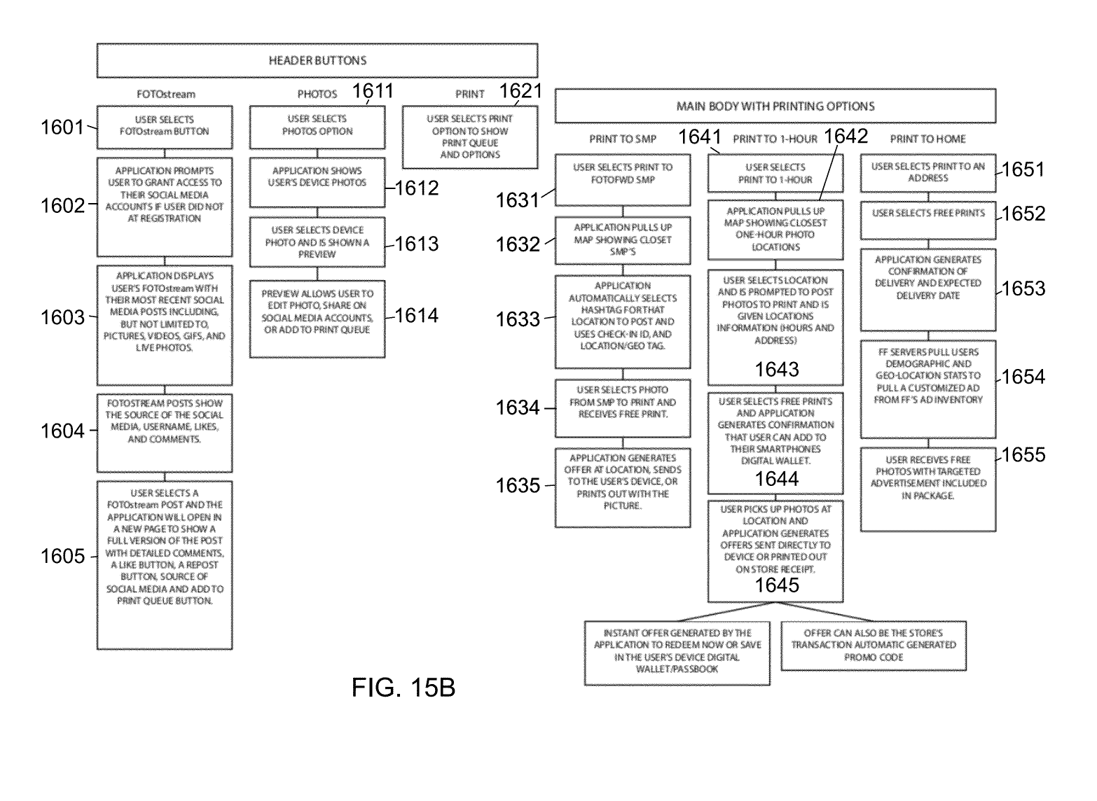

FIGS. 15A and 15B depict the exemplary process flow of a user utilizing an application that communicates with the social media experiential platform on their computing device. Initially in step 1401, the user downloads the application through a network. In this exemplary process the network is the Internet. Next in step 1402, the user creates a user profile that is stored on the social media experiential platform or logs into a previously created user profile. Information stored in the user profile can include a name, age, address, gender, and other information pertinent for the social media experiential platform to determine the demographic of the user profile. Further, in step 1403, the user grants the application access to the photo library of the computing device. Thereafter in step 1404, the user stores their authentication information for at least one social network provider. After logging into the application, the user is displayed a homepage in step 1405 with options to print digital images, preview a list of posts from social network provider(s) utilizing a unified interface, and preview digital images to print.

As shown in FIG. 15A, interface 1500 of the homepage displayed to the user comprises top corner buttons 1502, header buttons 1504, main body 1506. Top corner buttons 1502 includes a button to open and close menu 1508. In this embodiment, menu 1508 allows the user to view their account information, preview digital images, view a lists of posts from social network providers, and print digital images. Global button 1510 allows the user to select a retail location or social media printer that is near the current location of the computing device. Top corner buttons 1502 further includes camera button 1512. Camera button 1512 preferably allows the user to access the camera of the computing device to take digital images to print or share with their social network providers. Header buttons 1504 comprises buttons to view a preview of digital images, view a list of posts from social network providers, and print digital images. Main body 1506 comprises options to print a digital image at a social media printer, print a digital image at a retail location for pickup, and deliver the printed digital image to an address.

Step 1601 through step 1605 shown in FIG. 15B, depict the user process of viewing a list of posts from a plurality of social network providers utilizing a unified interface. In step 1601, the user selects the stream button on interface 1500 described in FIG. 15A. Next in step 1602 the application prompts the user to enter their authentication information for a social network provider. Thereafter in step 1603, the application displays a list of recent posts from the user's social network providers including, but not limited to, photos and videos. In step 1604, the application displays a summary of the posts displayed (e.g. source, comments, likes, etc.) in step 1603. Next in step 1605, the user can select a post to display detailed information about the post, press a like button, press a repost button, and add the post to a print queue.

Step 1611 through step 1614 depict the exemplary user process of previewing a digital image. In step 1611, the user selects a photo button on interface 1500 described in FIG. 15A. In step 1612, the application displays the digital images stored on the user's computing device. Next in step 1613, the user selects a digital image and is shown a preview. Finally in step 1614, the application allows the user to edit the digital image, share the digital image on their social network providers utilizing a unified interface, or add the digital image to a print queue. In step 1621, the user selects the print button on interface 1500 described in FIG. 15A. Thereafter the user is displayed the print queue.

Step 1631 through 1635 depict the exemplary user process of printing a digital image at a social media printer. In step 1631, the user selects to print to a social media printer on interface 1500 described in FIG. 15A. In step 1632, the application pulls a map of the social media printers near the computing device. In step 1633, the application automatically selects tags based on the location of the social media printer selected by the user. Thereafter in step 1634, the user selects a digital image for the social media printer to print at preferable no cost to the user. Finally in step 1635, the application selects an offer to display to the user's computing device or print at the social media printer.

Step 1641 through step 1645 depict an exemplary user process of printing a digital image at a retail location. In step 1641, the user selects to print to a retail location on interface 1500 described in FIG. 15A. Next in step 1642, the application pulls a map of the retail locations to print a digital image. In step 1643, the user selects a retail location and is prompted to select a digital image to print at the location. The user is provided the location, phone number, and hours of the retail location selected. In step 1644, the user confirms printing the digital image at the location and the application generates a confirmation. Next in step 1645, the user picks up the printed digital image at the selected retail location. The application can also select an offer to display on the user's computing device or print the offer on a receipt. The offer displayed can be immediately redeemed or saved. The offer can also be a promo code that the user can use at the retail location.

Step 1651 through step 1655 depict the exemplary user process of mailing a printed digital image to an address. In step 1651, the user selects to print a digital image to an address on interface 1500 described in FIG. 15A. Next in step 1652, the user selects to print a digital image at no cost. In step 1653, the application provides a confirmation of the expected delivery date of the printed digital image. Thereafter in step 1654, the social media experiential platform pulls the users demographic from their user profile and location to select an advertisement to include with the printed digital image. Finally in step 1655, the printed digital image is mailed to the selected address and includes a targeted advertisement.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. It will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method comprising the steps of:
capturing a digital image on a computing device at an event;
connecting the computing device to a social media experiential platform;
creating a post comprising the digital image and at least one tag;
posting the post to at least one social network provider; and
printing a photograph of the digital image.

2. The method of claim 1, wherein the step of printing a photograph of the digital image comprises:
transmitting the digital image to a module comprising an interactive touchscreen display; and
printing a photograph from the module comprising the digital image and a sponsor banner;
wherein the module is located at the event.

3. The method of claim 1, wherein the step of printing a photograph of the digital image comprises:
forming a list of retail locations;
selecting a retail location from the list;
transmitting the digital image to the selected retail location; and
printing a photograph at the retail location.

4. The method of claim 3, further comprising:
providing at least one printing material to the retail location at no cost; and
printing a photograph comprising the digital image and a sponsor banner.

5. The method of claim 1, wherein the step of printing a photograph of the digital image comprises:
selecting a mailing address; and
mailing a photograph comprising the digital image and a sponsor banner to the mailing address.

6. The method of claim 1, further comprising the steps of:
generating social media awareness for a venue; and
providing analytics on the post.

7. The method of claim 1, further comprising the step of forming a list of digital images captured at the event.

8. The method of claim 1, further comprising the step of managing the post to a plurality of social network provides and printing a photograph of the digital image utilizing a unified interface.

9. A method comprising the steps of:
capturing a digital image on a computing device at an event;
connecting the computing device to a social media experiential platform;
creating a post comprising the digital image and at least one tag;
posting the post to at least one social network provider;
printing a photograph of the digital image; and
invoicing the cost of at least one printing material to a sponsor;
wherein the at least one tag promotes the at least one sponsor.

10. The method of claim 9, wherein the step of printing a photograph of the digital image comprises:
transmitting the digital image to a module comprising an interactive touchscreen display; and
printing a photograph from the module comprising the digital image and a sponsor banner;
wherein the module is located at the event.

11. The method of claim 10, wherein the step of transmitting the digital image to the module utilizes near field communication.

12. The method of claim 9, wherein the step of printing a photograph of the digital image comprises:
forming a list of retail locations;
selecting a retail location from the list;
transmitting the digital image to the selected retail location; and
printing a photograph at the retail location.

13. The method of claim 9, wherein the step of printing a photograph of the digital image comprises:
selecting a mailing address; and
mailing a photograph comprising the digital image and a sponsor banner to the mailing address.

14. The method of claim 9, further comprising the step of offering a discount on a product of at least one sponsor.

15. The method of claim 10, wherein the step of transmitting the digital image to the module utilizes a Bluetooth beacon.
